(19) United States
(12) Patent Application Publication
(10) Pub. No.: US 2017/0144823 A1
(43) Pub. Date: May 25, 2017

(54) SILICONE FOOD STORAGE CAN

(71) Applicant: Davina Warman, Broomfield, CO (US)

(72) Inventor: Davina Warman, Broomfield, CO (US)

(21) Appl. No.: 15/236,706

(22) Filed: Aug. 15, 2016

Related U.S. Application Data
(60) Provisional application No. 62/386,127, filed on Nov. 19, 2015.

(51) Int. Cl. B65D 81/34; B65D 43/02; B65D 81/20; B65B 25/22; B65B 63/08; B65D 21/02; B65C 3/08; A23L 3/10; B65B 7/28

(52) U.S. Cl. CPC B65D 81/3453; A23L 3/10; B65D 43/02; B65D 81/2015; B65B 7/28; B65B 63/08; B65D 21/022; B65C 3/08; B65B 25/22; A23V 2002/00

(57) ABSTRACT

A reusable silicone food storage container includes a silicone canister having a base and at least one side extending from an outer periphery of the base such that the base and the at least one side define a compartment that has a proximal end near the base and a distal end away from the base. The distal end of the compartment includes a mating feature. A lid is removably coupled with the silicone canister configured to engage with the mating feature and to cover the storage compartment. The lid, when engaged with the mating feature, is configured to vacuum seal the silicone canister when the silicone food storage container is cooled after being heated to boil at least a portion of a food product within the storage compartment. The canister or the lid defines an opening configured to receive a utensil for prying the lid from the vacuum sealed canister.

### CROSS-REFERENCES TO RELATED APPLICATIONS

This Application claims priority to U.S. Provisional Patent Application No. 62/386,127 filed Nov. 19, 2015, entitled “SILICAN,” the entire disclosure of which is hereby incorporated by reference, for all purposes, as if fully set forth herein.

### BACKGROUND OF THE INVENTION

Typically, preserved food for sale is packaged in tin or other metallic cans, none of which are good for the environment. These cans are not reusable, may be easily dented, and oftentimes require can openers to open the cans. Dented cans lead to a loss of merchandise, and the use of a can opener can create sharp and/or jagged edges that may cause injury to users and others. Additionally, the metals used to form the cans may taint the taste of food. The metallic cans are not safe to use in microwaves, necessitating the use of additional containers if a user wishes to heat the contents of the cans. Additional problems arise due to it being inadvisable to freeze or refrigerate the cans, as some of the metallic elements may leach into the food, which can be quite dangerous.

### BRIEF SUMMARY OF THE INVENTION

Embodiments of the invention provide systems and methods for canning foods using silicone cans or other storage containers. In some embodiments, the silicone container may be a can, closely resembling a tin food can in appearance. The silicone can may include a base having at least one side extending around an outer periphery of the base. The base and side(s) may define an open storage compartment within which food may be stored. In some embodiments, the sides may include one or more external indentations, ridges, and/or other features that allow a label to be applied to an outside surface of the canister and to help maintain the label in the proper position. The silicone can may also include a lid configured to sit atop and close the storage compartment and be opened without the use of a can opener. The containers described herein may be filled and sealed using conventional canning processes.

In one aspect, a reusable silicone food storage container is provided. The food storage container may include a silicone canister having a base and at least one side extending from an outer periphery of the base such that the base and the at least one side define a storage compartment. The storage compartment may have a proximal end near the base and a distal end away from the base. The distal end of the storage compartment may include a mating feature. The food storage container may include a lid removably coupled with the silicone canister configured to engage with the mating feature and to cover the storage compartment. The lid, when engaged with the mating feature, may be configured to vacuum seal the silicone canister when the silicone food storage container is cooled after being heated to boil at least a portion of a food product within the storage compartment. At least one of the silicone canister or the lid may define an opening configured to receive at least a portion of a utensil for prying the lid from the vacuum sealed silicone canister.

In another aspect, a reusable silicone food storage container may include a silicone canister having a base and at least one side extending from an outer periphery of the base such that the base and the at least one side define a storage compartment. The storage compartment may have a proximal end near the base and a distal end away from the base and a medial portion positioned therebetween. The distal end of the storage compartment may include a mating feature. A diameter of the medial portion may be smaller than a diameter of the proximal end and a diameter of the distal end. The food storage container may also include silicone lid removably coupled with the silicone canister configured to engage with the mating feature and to cover the storage compartment. The silicone lid, when engaged with the mating feature, may be configured to vacuum seal the silicone canister when the silicone food storage container is cooled after being heated to boil at least a portion of a food product within the storage compartment. At least one of the silicone canister or the silicone lid may define an opening configured to receive at least a portion of a utensil for prying the lid from the vacuum sealed silicone canister.

In another aspect, a method of using a reusable silicone food storage container is provided. The method may include providing a silicone food storage container. The food storage container may include a silicone canister having a base and at least one side extending from an outer periphery of the base such that the base and the at least one side define a storage compartment. The storage compartment may have a proximal end near the base and a distal end away from the base. The distal end of the storage compartment may include a mating feature. The food storage container may also include a lid. At least one of the silicone canister or the lid may define an opening. The method may also include filling at least a portion of the storage compartment with a food product and fitting the lid over the storage compartment such that the lid engages with the mating feature of the storage compartment. The method may further include applying heat to the filled silicone food storage container. The heat may be sufficiently high to boil at least a portion of the food product. The method may include cooling the filled silicone food storage container, thereby vacuum sealing the storage compartment by securing the lid onto the silicone food storage container.

### BRIEF DESCRIPTION OF THE DRAWINGS

FIG. 1A depicts an isometric view of a silicone food storage container in a disassembled state according to embodiments.

FIG. 1B depicts an isometric view the silicone food storage container of FIG. 1A in an assembled state according to embodiments.

FIG. 1C depicts a side cross sectional view of the silicone food storage container of FIG. 1A in a disassembled state according to embodiments.

FIG. 1D depicts a side cross sectional view of the silicone food storage container of FIG. 1A in an assembled state according to embodiments.

FIG. 1E depicts a bottom isometric view of the silicone food storage container of

FIG. 1A in a disassembled state according to embodiments.

FIG. 1F depicts a bottom view of the silicone food storage container of FIG. 1A in a disassembled state according to embodiments

FIG. 1G depicts a top view of the silicone food storage container of FIG. 1A in a disassembled state according to embodiments.

FIG. 2 depicts an isometric view of a silicone food storage container in a disassembled state according to embodiments.

FIG. 3 is a flowchart depicting a method of using a silicone food storage container according to embodiments.

### DETAILED DESCRIPTION OF THE INVENTION

Embodiments of the invention provide systems and methods for canning foods using silicone cans or other storage containers. Silicone containers, including cans, provide numerous advantages over metallic cans. Silicone cans may be washed and sterilized, and may then be reused to store a same or different food product. If the can needs to be replaced, such as due to wear or damage, the silicone may be recycled by a silicone manufacturer. Silicone can withstand relatively extreme temperatures, both cold and hot, without breaking down or changing properties. Thus, the cans may be placed in the oven, refrigerator, or freezer. Additionally, silicone is a microwave safe material so the contents may be warmed in a microwave without using an additional container or dish. As a strong insulator, silicone allows the cans to be handled without oven mitts or gloves when exposed to high temperatures. Additionally, due to the flexible nature of silicone, the containers may be more dent and damage resistant than conventional food storage containers.

Silicone is a commonly used in food handling, such as with mixing bowls, measuring cups, bakeware, and the like, and is very safe for use with food storage and preparation. Silicone containers may be lightweight, stackable, and dent resistant. A lid of the silicone can may be removed without the use of a can opener. Instead, the lid may be removed using a spoon, fork, or other utensil or tool. This ensures that there are no dangerous shape or jagged edges that may cause injury to humans or animals. Oftentimes, the silicone cans may be opaque. This helps prevent spoilage and/or other ill effects as a result of exposure to UV light, such as sunlight.

In some embodiments, silicone cans may be made by molding and/or otherwise shaping food grade silicone into a desired size and shape. In some embodiments, silicone containers may be produced in dimensions and/or storage volumes common to conventional food storage cans, such as 6, 12, 16, and/or 30 ounces, and the like. It will be appreciated that any size of container may be formed and that scaling up and/or scaling down the container size may also include making the silicone components thinner or thicker to accommodate various weights and pressures of contents.

Embodiments provide reusable silicone food containers. In some embodiments, the silicone container may be a can, closely resembling a tin food can in appearance. The silicone can may include a base having at least one side extending therefrom and along an outer periphery of the base. The base and side(s) may define an open storage compartment within which food may be stored. Oftentimes, the base and side may form a cylindrical canister, however it will be appreciated that other shapes, such as rectangular prisms, cubes, and/or other shapes may be used. The entire canister may be formed from silicone. For example, silicone having a hardness of between about 70 Shore A and 85 Shore A may be used for the base and side(s), with a hardness of about 80 Shore A being common. In some embodiments, the base may be between about 7 mm and 25 mm thick, while the side(s) may be between about 5 mm and 20 mm thick. Such a combination of thickness and hardness enables the silicone can to be sufficiently strong and rigid to hold food contents while still having enough flexibility to resist denting. In some embodiments, the sides may include one or more indentations, ridges, and/or other features that aid in the adherence of a label to an outside surface of the canister and to help maintain the label in the proper position.

The silicone can may also include a lid configured to sit atop and close the storage compartment. The lid may be configured to engage with a mating feature on the canister and/or within the storage compartment. In some embodiments, the mating features may include two or more ribs, rims, ridges, or annular elements that extend inward from the storage compartment. The annular elements may be spaced apart approximately a thickness of the lid. Oftentimes, a bottom one of the annular elements may be wider, such that a distance between inner edges on opposite sides of the bottom annular element are closer together than the inner edges of the topmost annular element. This larger/wider bottom rib prevents the lid from falling into the canister, while the thinner top rib allows the lid to be more easily inserted and removed from the canister. Additionally, this design may help with forming a suction/seal between the lid and canister. In some embodiments, a top one of the annular elements may be only partially complete such that the annular element includes a gap and is c-shaped. This gap may provide an opening through which a fork, spoon, and/or other utensil or tool may be inserted to pry the lid off the canister. In other embodiments, the lid may include a slot, such as a slot extending partially into a top surface of the lid, that allows a utensil to be inserted for prying or otherwise removing the lid. In some embodiments, the slot may extend into the top surface of the lid at a non-orthogonal angle, while in other embodiments the slot may be orthogonal to the top surface. In some embodiments, the annular elements may be formed from the same silicone material as the rest of the canister, while in other embodiments, a softer silicone may be used. For example, the annular elements may be formed of silicone having a hardness of between about 50 Shore A and 70 Shore A. The lid may snap into or otherwise couple with the annular elements. The softer silicone makes the insertion of the lid easier by requiring less force to snap in the lid.

The containers described herein may be filled and sealed using conventional canning processes. For example, a food product may be provided within the storage compartment. The lid may be inserted between the annular members to close the storage compartment. The closed container may then be exposed to heat sufficiently high to boil at least a portion of the food product, causing some of the water and air from within the storage compartment to escape from the storage compartment near the interface with the lid. The reduction in water and air results in a reduction of pressure within the storage compartment when the container is cooled, which creates a vacuum seal between the lid and the storage compartment, thereby providing an airtight and watertight seal that meets food safety standards.

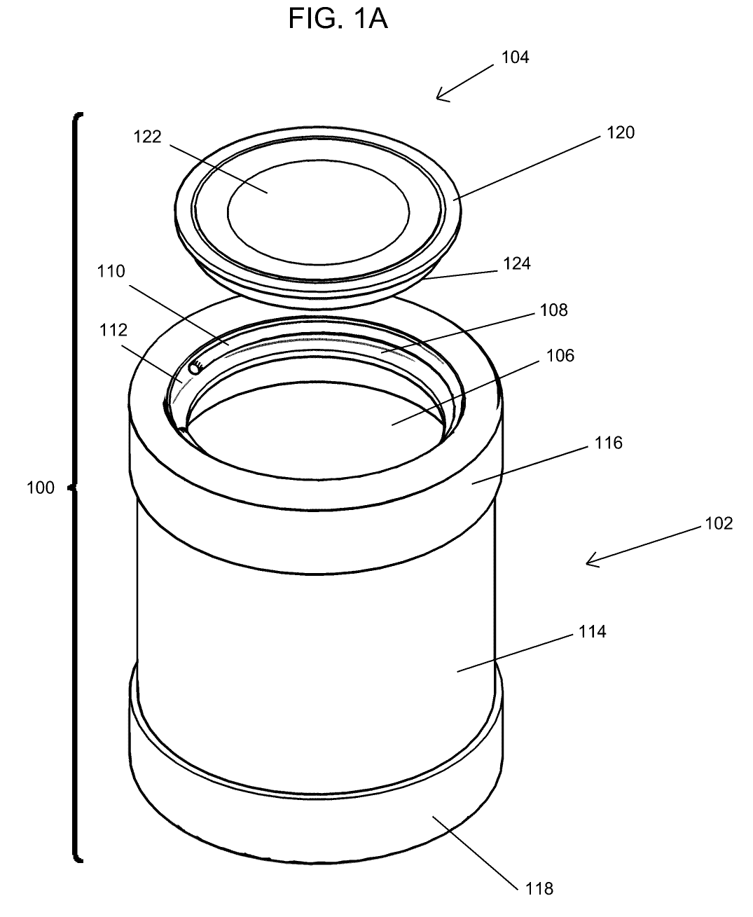

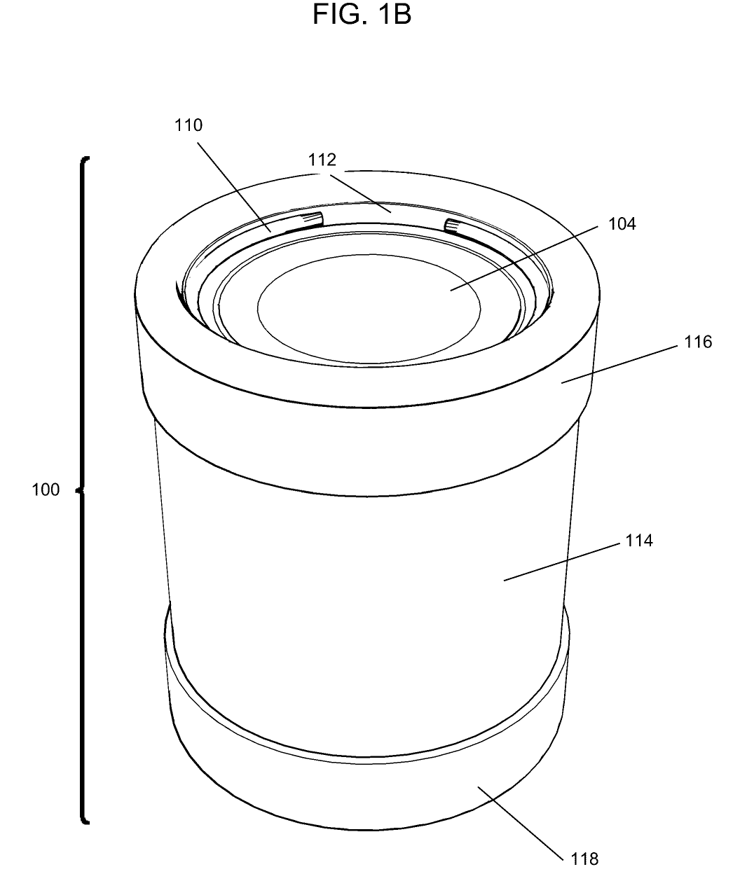

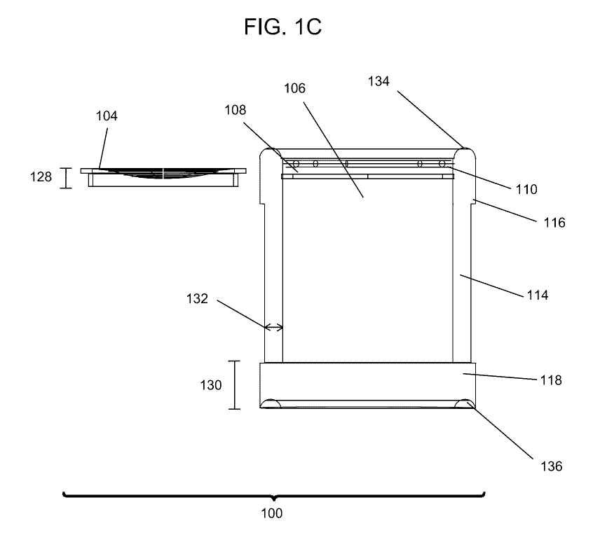

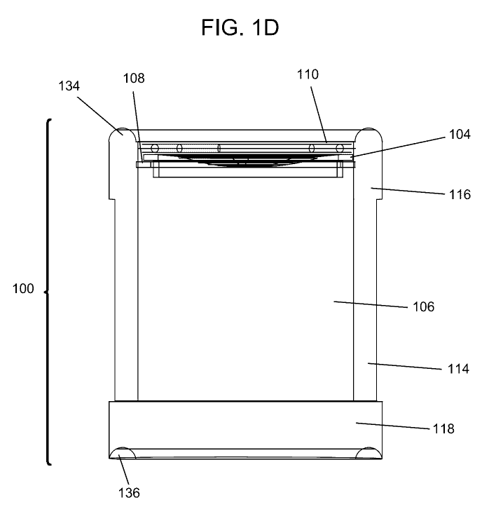

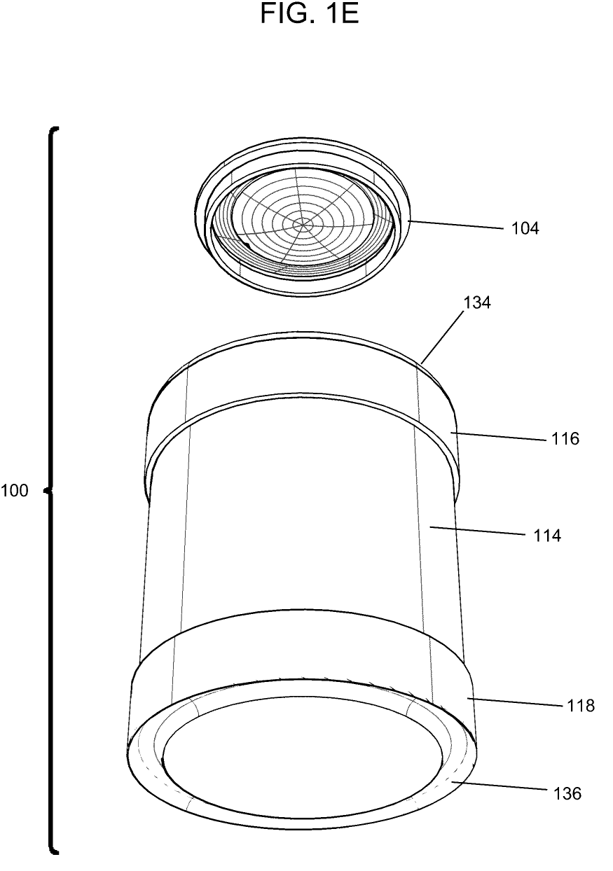

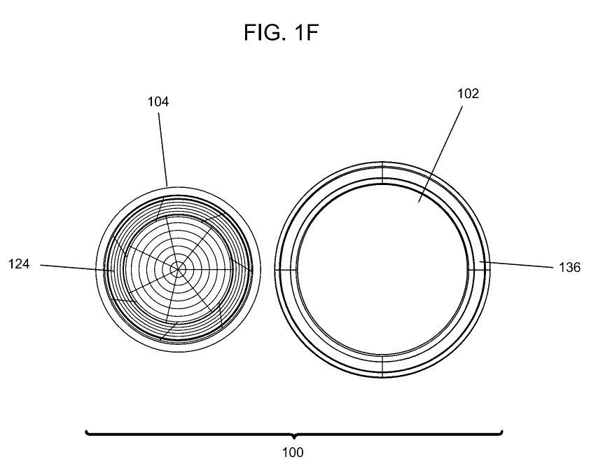

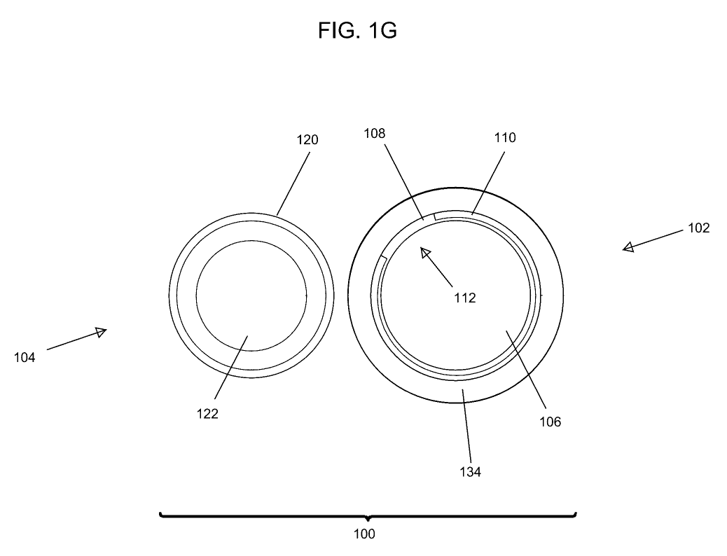

Turning now to the figures, one embodiments of a silicone food storage container 100 is shown in FIG. 1A. Food storage container 100 may include a canister 102. Oftentimes, canister 102 may be cylindrically shaped, similar to conventional tin cans, although any shape of canister 102 may be formed. Canister 102 may be formed entirely from silicone. For example, silicone having a hardness of at least 70 Shore A, typically about 80 Shore A, may be used to form canister 102, although harder silicones may also be used. Canister 102 may include a base and one or more sides or walls that extends upward from the base and along an outer periphery of the base. The base and sides of the canister 102 define an open storage compartment 106 that may be filled with a food product. The storage compartment 106 may include a mating feature configured to secure a lid 104 over the storage compartment 106. The mating feature may include a top edge of the storage compartment that includes a lower rim or ridge 108 that extends partially into the storage compartment 106. The mating feature may also include an upper rim or ridge 110. An outer edge 120 of the lid 104 may be snapped or otherwise positioned between the lower rim 108 and the upper rim 110, with the outer edge 120 being positioned atop at least a portion of the lower rim 108. The lower rim 108 and the upper rim 110 may be spaced apart a distance approximately the thickness of the lid 104.

In some embodiments, both the lower rim 108 and the upper rim 110 may be formed of the same silicone as the rest of canister 102. However, in some embodiments, the upper rim 110 may be formed of a softer silicone. For example, upper rim 110 may be formed of a silicone having a hardness of between about 50-70 Shore A. The use of a softer silicone for the upper rim 110 reduces the amount of force necessary to snap the lid 104 underneath the upper rim 110, as the softer silicone is more flexible than the harder silicone. In some embodiments, softer silicone may be formed separately from the harder silicone and may be fused or otherwise secured to the harder silicone using an adhesive, radio frequency (RF) welding, 3D printing techniques, and/or other coupling techniques. In some embodiments, the lower rim 108 may be wider than the upper rim 110, such that a distance between inner edges on opposite sides of the lower rim 108 are closer together than the inner edges of the upper rim 110. This larger/wider lower rim 108 helps support lid 104 and prevents the lid 104 from falling into the canister 102, while the upper rim 110 allows the lid 104 to be inserted and removed from the canister 102.

In some embodiments, the upper rim 110 may be only partially complete. In other words, the upper rim 110 may not extend fully around an outer periphery of the storage compartment. For example, the upper rim 110 may be c-shaped. Ends of the upper rim 110 may form a gap 112. This gap 112 may provide an opening through which a fork, spoon, and/or other utensil or tool may be inserted to pry the lid 104 off the canister 102. In other embodiments, the lid 104 may include a slot (not shown), such as a slot extending partially into a top surface of the lid 104, that allows a utensil to be inserted for prying or otherwise removing the lid 104. In some embodiments, the slot may extend into the top surface of the lid 104 at a non-orthogonal angle, while in other embodiments the slot may be orthogonal to the top surface.

Canister 102 may include a proximal end 118 near its base, a distal end 116 positioned at a top side of the canister 102, and a medial portion 114 positioned between the proximal end 118 and the distal end 116. In some embodiments, the canister 102 may have a substantially constant diameter along its entire body. In other embodiments, the diameter may vary. As just one example, a diameter along the medial portion 114 may be smaller than a diameter at the proximal end 118 and/or the distal end 116. Such a configuration provides an indented portion that may help secure a label on the canister 102. For example, a label may be sized to fit around the smaller diameter of the medial portion 114 while the larger ends prevent the label from slipping off.

Lid 104 may be configured to cover the storage compartment 106, with a top surface of an outer edge 120 resting atop the lower rim 108 and a bottom surface of outer edge 120 sitting underneath upper rim 110. In some embodiments, lid 104 may include an indented center portion 122. The indented center portion 122 may help with the sealing of the container 100 and/or indicate whether the container is properly sealed. For example, the indented center portion 122 may pop down when the container 100 is sealed and pop up when the seal is broken. In some embodiments, to ensure that all portions of lid 104 are sufficiently thick to remain rigid, a lower surface 124 of the center portion 122 may protrude downward, into the storage compartment 106, which may also help with the sealing of the container 100. Oftentimes, lid 104 may be formed from silicone, such as silicone of the same hardness as the rest of the container 100. In other embodiments, a metal lid, such as a lid made of aluminum may be used. In some embodiments, lid 104 may include a metal core surrounded with silicone. It will be appreciated that lids of other materials, alone or in combination with metals and/or silicone may also be used, as long as the compositions provide sufficient rigidity and sealing ability.

FIG. 1B shows lid 104 inserted within the mating feature, such that an underside of the lid 104 is sitting atop the lower rim 108 and upper rim 110 is pressing against a top surface of lid 104 to secure the lid 104 in place over the storage compartment 106. When a food product is provided in the storage compartment 106 and the lid 104 is in place over the storage compartment 106, a heating process may be commenced to begin sealing the food storage container 100. Oftentimes, this involves submerging at least a portion of the food storage container 100 into a heated and/or boiling liquid, although other forms of heating, such as ovens may be used. As the food product is heated within the food storage container 100, some or all of the food product may begin to boil, which not only can sterilize the food product but also causes some of the water (in the form of water vapor) and air from within the storage compartment 106 to escape from the storage compartment 106 by seeping past the lid 104. The food storage container 100 is then cooled, such as by removing the food storage container 100 from the heat source and/or introducing the food storage container 100 to a cooling fluid such as ice water. The cooled contents are now in a lower pressure environment due to the loss of water and air from within the storage compartment 106. This lower pressure creates vacuum seal between the storage compartment 106 and the lid 104. Gap 112 leaves a portion of the outer edge 120 of the lid 104 exposed. After the food storage container 100 has been vacuum sealed, a tool or utensil, such as a spoon, may be inserted into the gap 112 and positioned under the exposed portion of the outer edge 120. The utensil may then be used to pry the lid 104 away from the canister 102, thereby breaking the vacuum seal and exposing the food product stored within the storage compartment 106.

FIG. 1C shows a side cross section of food storage container 100. As just one example, food storage container 100 may hold 16 ounces of a food product, although other volumes are contemplated. In some embodiments, lid 104 may have portions having a thickness 128 ranging between about 3 mm and 10 mm. For example, the outer edge 120 may form a flange that serves as the portion of the lid 104 that engages with the rims of the mating feature. This flange may have a minimum thickness of the lid 104, while a medial portion and/or lower surface 124 may be thicker. The lower rim 108 and upper rim 110 may be spaced apart a distance similar to the thickness of the flange. For example, lower rim 108 and upper rim may be spaced apart between about 4 mm and 11 mm. In some embodiments, the upper rim 110 and lower rim 108 may be spaced apart by a slightly smaller distance than the thickness of the flange, especially in embodiments where the upper rim 110 is formed of a softer silicone. For example, the upper rim 110 and lower rim 108 may be placed between about 0.5 mm and 2 mm closer together than the thickness of the flange. This allows the top surface of lid 104 to sit against lower rim 108 while the bottom surface of lid 104 presses into and deforms a bottom surface of upper rim 110, thereby securing the lid 104 in position. Lid 104 is shown positioned between the lower rim 108 and upper rim 110 in FIG. 1D.

Turning back to FIG. 1C, the base may have a thickness 130 of between about 10 mm and 25 mm, with the sides or walls having a thickness 132 of between about 5 mm and 15 mm. Such thicknesses ensure that the silicone is sufficiently strong and rigid to contain a volume of food product while maintaining its shape and resiliency. It will be appreciated that the thickness of the various components of food storage container 100 may vary as the food storage container is sized up or down. For example, to withstand the weight of larger volumes of food, larger containers may require thicker sides and a thicker base. Similarly, smaller containers may take advantage of thinner walls to reduce material costs and weight.

In some embodiments, the canister 102 may include a raised upper edge 134 and a recess 136 formed in a bottom surface of the canister 102. The raised upper edge 134 of one canister 102 may be inserted in the recess 136 of another canister 102 to help stack multiple canisters 102. This allows many canisters 102 to be stacked atop one another, with the raised upper edges 134 engaging with the recesses 136 to align and stabilize the stack of canisters 102. Oftentimes, the raised upper edges 134 and recesses 136 extend along all or substantially all of the outer periphery of the canister 102, however other designs may be contemplated. For example, a series of one or more smaller raised portions, such as detents or other protrusions may be included on a top edge of the canister 102. As just one example, a top edge of the canister 102 may include a series of bumps positioned around an outer periphery of the canister 102. These bumps may be configured to interface with a circular recess 136 of the bottom surface of another canister 102, such as the recess 136 shown in FIGS. 1E and 1F. Recess 136 is often sized to be approximately the same size as (or slightly larger than) the raised upper edge 134, such that a raised upper edge 134 may securely nest within the recess 136 of another canister 102. Similarly, in some embodiments, rather than including a circular and/or annular recess 136, a series of smaller indentations or recesses 136 may be provided in the base of the canister 102. While shown with a raised or protruding portion on the top edge and a recess in the bottom edge of the canister 102, it will be appreciated that in some embodiments, the position of the protrusions and recesses may be reversed. In some embodiments, the top and/or bottom of canister 102 may include both protrusions and recesses. Any combination of protrusions, recesses, and/or other mating features may be utilized that help provide alignment and stability when stacking multiple canisters 102.

FIG. 1G shows a top view of canister 102 and lid 104. Oftentimes, lower rim 108 is wider than upper rim 110. The thinner upper rim 110 makes it easier to insert the lid 104 underneath, while the wider lower rim 108 provides a larger base upon which the lid 104 may be supported (and which creates the seal when placed next to the lid 102). In some embodiments, gap 112 may extend along a small portion of an outer periphery of the upper rim 110, while in other embodiments, the gap 112 may be larger and/or multiple gaps 112 may be included. For example, two, three, four or more gaps 112 may be positioned around the upper rim 110 at relatively equal intervals along the periphery of the storage compartment 106. Oftentimes, gap 112 will be sized to receive a portion of a utensil, such as the end of a spoon. This allows the end of the utensil to be inserted into the gap 112 and underneath an outer edge 120 of lid 104 such that the lid 104 may be pried off of the canister 102.

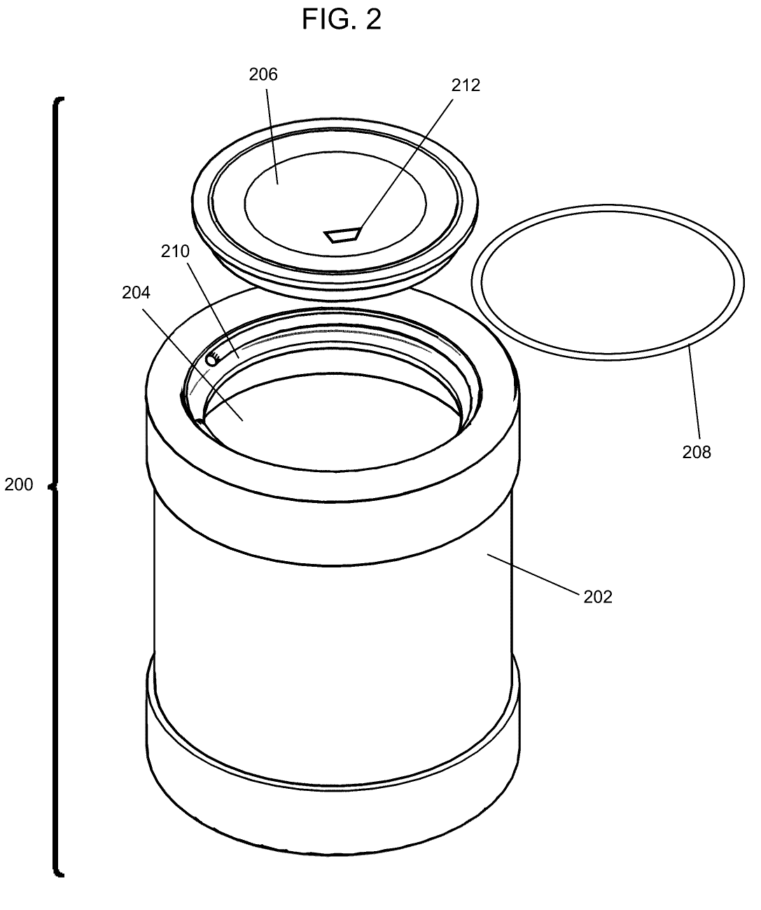

FIG. 2 shows another embodiment of a silicone food storage container 200. Food storage container 200 may be similar to food storage container 100. For example, food storage container 200 may include a canister 202 defining a storage compartment 204 that is sealable using a lid 206. Food storage container 200 may also include a gasket 208. Gasket 208 may be annular shaped and be sized to sit against a lower ridge or mating feature 210 of the storage compartment 204 and underneath the lid 206, helping to form a seal between the lid and the canister 202. Gasket 208 may be formed of silicone, rubber, or other flexible and/or malleable material. In some embodiments, the gasket 208 may be sized to match an outer rim of the lid 206 such that the gasket 208 fits around a medial portion of the lid 206. In some embodiments, the lid 206 may include a slit 212 within which a utensil may be inserted to pry the lid from the canister 202. The slit may extend partially though a thickness of lid 206 at an orthogonal or other angle relative to a top surface of the lid 206.

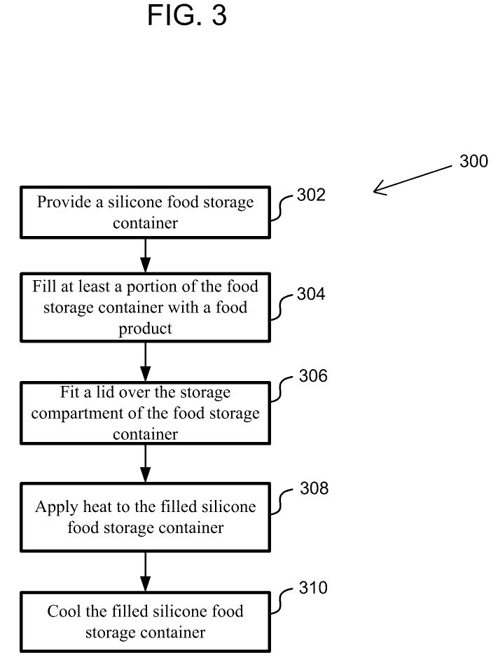

FIG. 3 depicts a process 300 for using a reusable silicone food storage container. Process 300 begin at block 302 by providing a silicone food storage container. The food storage container may be similar to any of the food storage containers described herein. At least a portion of the storage compartment of the food storage container may be filled with a food product at block 304. A lid, which may be made of metal, silicone and/or other material, may be fit or otherwise positioned over the storage compartment at block 306. This may include ensuring that the lid engages with a mating feature of the storage compartment to secure the lid over the storage compartment. For example, the lid may be placed between a lower rim and an upper rim of the mating feature, with an underside of the lid resting atop at least a portion of the lower rim and with the upper rim providing resistance against the top side of the lid to secure the lid in place. In some embodiments, this may include positioning a gasket into the storage compartment between a lower rim of the mating feature and a bottom surface of the lid. At block 308, heat may be applied to the filled silicone food storage container. In some embodiments, this may include submerging at least a portion of the filled silicone storage container in a boiling fluid. The heat may be sufficiently high to boil at least a portion of the food product. The boiling sterilizes the food product and causes some of the water (in the form of water vapor) and air from within the storage compartment to escape from the interface between the lid and storage compartment. After boiling at least a portion of the food product for a period of time, the filled silicone food storage container may be cooled at block 310, thereby vacuum sealing the storage compartment by securing the lid onto the silicone food storage container. For example, the food storage container is removed from the heat source and/or introduced to a cooling fluid, such as ice water. The cooled contents are now in a lower pressure environment due to the loss of water and air from within the storage compartment, which creates vacuum seal between the storage compartment and the lid. It will be appreciated that process 300 is merely one example of a canning process, and that other known canning and/or heating techniques may be used in conjunction with the silicone food storage containers described herein.

In some embodiments, a label may be applied to a medial portion of the silicone canister. Oftentimes, the medial portion will have a smaller diameter than the two ends of the canister forming a sort of indentation. This allows the label to be secured within the indentation, with the larger ends helping to prevent the label from slipping off the canister. The label may be slid into position around the medial portion of the canister and/or adhered to the medial portion. In some embodiments, process 300 may include inserting a distal end of a spoon, a fork, utensil, or other tool into an opening or gap of the lid or canister and pressing a proximal end of the utensil toward the silicone food storage container to break the vacuum seal and remove the lid, thereby opening the silicone food storage container. For example, a spoon may be inserted into a gap in an upper rim of a mating feature, with the spoon being positioned under an exposed portion of the outer edge of the lid. The utensil may then be used to pry the lid away from the canister to break the vacuum seal so the lid may be removed. As another example, the lid may include a slit within which a utensil may be inserted to pry the lid from the canister. In some embodiments, the method may also include stacking the silicone food storage container on another silicone food storage container such that a raised top edge of the another silicone food storage container is received within a recess in a bottom surface of the base of the silicone food storage container.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A reusable silicone food storage container, comprising:
a silicone canister comprising a base and at least one side extending from an outer periphery of the base such that the base and the at least one side define a storage compartment, the storage compartment having a proximal end near the base and a distal end away from the base, wherein the distal end of the storage compartment comprises a mating feature;
a lid removably coupled with the silicone canister configured to engage with the mating feature and to cover the storage compartment, wherein:
the lid, when engaged with the mating feature, is configured to vacuum seal the silicone canister when the silicone food storage container is cooled after being heated to boil at least a portion of a food product within the storage compartment; and
at least one of the silicone canister or the lid defines an opening configured to receive at least a portion of a utensil for prying the lid from the vacuum sealed silicone canister.

2. The reusable silicone food storage container of claim 1, wherein:
the canister comprises a cylindrical shape.

3. The reusable silicone food storage container of claim 1, wherein:
the silicone canister and the lid each comprise silicone having a hardness of between about 70 Shore A and 85 Shore A.

4. The reusable silicone food storage container of claim 1, wherein:
the mating feature comprises silicone having a hardness of between about 70-75 Shore A.

5. The reusable silicone food storage container of claim 1, wherein:
the opening comprises a slit in a top surface of the lid.

6. The reusable silicone food storage container of claim 1, wherein:
the opening is defined by a gap in the mating feature of the storage compartment.

7. The reusable silicone food storage container of claim 1, wherein:
the mating feature comprises an upper rim and a lower rim; and
the lid is configured to seal the silicone canister when positioned between the upper rim and the lower rim.

8. A reusable silicone food storage container, comprising:
a silicone canister comprising a base and at least one side extending from an outer periphery of the base such that the base and the at least one side define a storage compartment, the storage compartment having a proximal end near the base and a distal end away from the base and a medial portion positioned there between, wherein the distal end of the storage compartment comprises a mating feature, wherein a diameter of the medial portion is smaller than a diameter of the proximal end and a diameter of the distal end;
a silicone lid removably coupled with the silicone canister configured to engage with the mating feature and to cover the storage compartment, wherein:
the silicone lid, when engaged with the mating feature, is configured to vacuum seal the silicone canister when the silicone food storage container is cooled after being heated to boil at least a portion of a food product within the storage compartment; and
at least one of the silicone canister or the silicone lid defines an opening configured to receive at least a portion of a utensil for prying the lid from the vacuum sealed silicone canister.

9. The reusable silicone food storage container of claim 8, wherein:
the silicone lid has a minimum thickness of between about 3 mm and 10 mm.

10. The reusable silicone food storage container of claim 1, wherein:
the at least one side has a thickness of between about 5 mm and 20 mm.

11. The reusable silicone food storage container of claim 1, wherein:
the base has a thickness of between about 10 mm and 25 mm.

12. The reusable silicone food storage container of claim 1, further comprising:
a gasket positioned between a bottom surface of the silicone lid and a portion of the mating feature.

13. The reusable silicone food storage container of claim 1, wherein:
the distal end of the silicone food storage container comprises a raised lip configured to be received within a recess in the base of another silicone food storage container when the food storage containers are stacked.

14. A method of using a reusable silicone food storage container, the method comprising:
providing a silicone food storage container comprising:
a silicone canister comprising a base and at least one side extending from an outer periphery of the base such that the base and the at least one side define a storage compartment, the storage compartment having a proximal end near the base and a distal end away from the base, wherein the distal end of the storage compartment comprises a mating feature;
a lid, wherein at least one of the silicone canister or the lid defines an opening;
filling at least a portion of the storage compartment with a food product;
fitting the lid over the storage compartment such that the lid engages with the mating feature of the storage compartment;
applying heat to the filled silicone food storage container, the heat being sufficiently high to boil at least a portion of the food product; and
cooling the filled silicone food storage container, thereby vacuum sealing the storage compartment by securing the lid onto the silicone food storage container.

15. The method of using a reusable silicone food storage container of claim 14, further comprising:
inserting a distal end of a utensil into the opening and pressing a proximal end of the utensil toward the silicone food storage container to break the vacuum seal and remove the lid, thereby opening the silicone food storage container.

16. The method of using a reusable silicone food storage container of claim 14, wherein:
fitting the lid over the storage compartment comprises positioning a gasket into the storage compartment.

17. The method of using a reusable silicone food storage container of claim 14, further comprising:
stacking the silicone food storage container on another silicone food storage container such that a raised top edge of the another silicone food storage container is received within a recess in a bottom surface of the base of the silicone food storage container.

18. The method of using a reusable silicone food storage container of claim 14, wherein:
the lid comprises metal.

19. The method of using a reusable silicone food storage container of claim 14, wherein:
applying heat to the filled silicone food storage container comprises submerging at least a portion of the filled silicone storage container within a boiling fluid.

20. The method of using a reusable silicone food storage container of claim 14, further comprising:
applying a label to a medial portion of the silicone canister, wherein:
the medial portion extends between the proximal end and the proximal end; and
a diameter of the medial portion is smaller than a diameter of the proximal end and a diameter of the distal end.
